(19) United States
(12) Patent Application Publication
(10) Pub. No.: US 2008/0152473 A1
(43) Pub. Date: Jun. 26, 2008

(54) Apparatus and Method for Handling Humid Products

(76) Inventors: Jan O. Buljo, Hundhamaren (NO); Reidar Hovtun, Borsa (NO); Kjell Fenheim, Trondheim (NO)

Correspondence Address: LADAS & PARRY LLP, 26 WEST 61ST STREET, NEW YORK, NY, 10023, US

(21) Appl. No.: 11/666,591

(22) PCT Filed: Oct. 28, 2005
(86) PCT No.: PCT/NO05/00411

§ 371 Date: Aug. 27, 2007

(30) Foreign Application Priority Data
Oct. 29, 2004 (NO) 20044707

(51) Int. Cl. B65G 47/90

(52) U.S. Cl. 414/751.1; 414/800

(57) ABSTRACT

The present invention concerns an apparatus for handling humid products. The apparatus includes a thermal face (1) with a cooled area (9) over at least a part of the face (1). At least one release element (2) is connected to the apparatus and includes at least one release shear. The release element (2) with the release shear is moveably provided in relation to the cooled area (9). Furthermore a method for handling humid products is described.

The present invention concerns a gripping tool apparatus for handling humid products including a cooled area for freeze bonding the humid product and a release element. Furthermore it is described a method for handling humid products.

There are today no good industrial solutions for gripping tools that can handle fresh and wet products or objects such as fillet of fish or meat, portion peaces, hams, sausage etc. Particularly, it has proved to be a problem to be able to grip humid objects that also includes hard elements such as bones or other hard materials.

For bonding humid products to a surface, it has previously been suggested to cool the surface, such that the humid product freezes onto the surface. An example of such solution is shown in JP 02113843 describing a method and an apparatus for skinning fish skin from fish. The publication describes that the fish skin is brought in contact with a smooth cooled metal face on a cooling element such that the skin freezes and bonds to the metal face for thereafter separating the fish meat from the skin. The remaining fish skin is removed from the metal face. In the publication it is described cooling of the surface to less than or equal to −5°. The fish skin is preferably divided in three parts along the spine and is brought in contact with the cooling elements to provide immediate freeze bonding of the skin. A thin blade, for instance a kitchen knife, is led between the fish meat and the skin, to skin the skin from the fish meat. The remaining fish skin on the cooling element is scraped off with the knife.

From NO 163351 it is shown a method for removing abdomen bones from fillet of fish by using a so-called freeze skinning machine. A freezing drum is used to freeze bond a fillet of fish with the skin towards the cooled drum and thereafter a knife cuts loose the fish meat while the skin follows the drum for thereafter to be scraped off.

Another apparatus where it is used freeze bonding is shown in WO 99/07228. Also here it is shown a method for mechanically treating fish or meat fillets or parts, where it is used a rotating freezing drum for securing the elements that are to be handled.

Common for these solutions is that it is used molecular forces that emerge in the transition between the object and the cooled face when a humid object freeze bonds to a metal face at a temperature below freezing.

None of the shown publications however shows an apparatus suitable for handling humid products for instance in connection with packaging and other handling of the products. Furthermore it is not shown a suitable release apparatus for actuate placement of the object that is to be handled.

The lack of suitable gripping apparatuses has often resulted in manual handling of this kind of objects and this kind of objects has not been an object for widespread handling with robots or other mechanical handling.

By using a gripping tool combined with a robot and for instance a vision system, industrial enterprises can achieve automatized handling operations in its line of production. Primarily it will be relevant to automatize packaging operations, for instance when feeding fillet pieces in deep drawers. Today it is often used at least two operators for each packaging machine. Faults often emerge because the operators spill fluid on the welding seams (the upper and lower foils are welded), such that a loss of vacuum occurs. Therefore a considerable amount of the packages must be reopened and repacked. This also distracts an operator at the outlet of the packaging machine. By using a gripping tool and robot, the gripping operation can be controlled in a way to avoid the above-mentioned problems. Feeding of fillet pieces in freezers is another relevant use of this type of gripping tools in connection with a robot and a vision system. Use of gripping tools for handling round fish is also relevant, for instance for feeding filleting machines. It is a similar need within the salt and the clipfish industry where a gripping tool can be used. Within the meat industry it is also a need for automatization of the handling operations, whether in connection with the sectors poultry, pork, mutton or beef.

Furthermore there are many other areas within the food industry and other areas of industry where it is a need for automatizating displacement tasks where the object allows use of this type of gripping tool.

Accordingly the present invention concerns an apparatus or a gripping tool for handling humid products with a thermal surface with a cooled area over at least a part of surface and the apparatus includes at least one, preferably on the thermal face situated, release element with at least one release shear, where the release element with the release shear is movably provided in relation to the cooled area. With a “thermal face” in this specification it is meant the face that at least partly includes cooled areas, and that the product or the object shall bond too by freeze bonding. The thermal surface may, as it will be described, also include cooled and heated areas, for instance in a pattern.

Objects where the surface has dried can for instance be moistened by using for instance a spray of water to ensure bonding.

It is formed a thin layer of ice on the surface of the object with sufficient bonding to the cooled area of the thermal face, such that the gripping tool can lift and move the object. A non-rigid and soft object (for instance a fillet) will get fixed to the gripping tool immediately when it is brought in contact with the frozen face. Thereby the object can be moved to a desired position by a robot or any other mechanism.

The cooled area can for instance be cooled to −15° C.

The at least one release shear may be an edge of at least one opening for exposing the cooled area, and an around the opening situated release face.

The release element can be designed to be able to move in a direction substantially parallel to the cooled area.

However the release element can move in any direction in relation to the cooled area as long as the release shear or the edge around the opening in the release element can be moved over the cooled face where the humid product is secured, to release this product. The release shear will cut the product clear from the face, or press this away from the face due to a wedge effect between the product and the cooled face when the release shear is pressed between these elements.

The release element can be made of a plate. The plate may be bendt such that it can be held around a body, and such that the plate can be parallely displaced in relation to the cooled surface. However the release element may well be shaped in any other way, as long as the release shear is allowed to slide over the thermal face.

The release element may include a plurality of openings in a pattern. It would be advantageous if the release element includes a plurality of openings with corresponding release shears such that the product that is held can be released over large parts of the cooled surface simultaneously to prevent the product from moving considerably when it is released. This can be important to ensure precision during release of the product. At the same time the length the release element must be moved to release the product is reduced, and this is advantageous to ensure quick delivery of the product, and a compact actuator and apparatus as a hole.

The release element can be adapted to be able to move at a distance sufficient such that the release face around the at least one opening can reach all of the cooled area exposed by the at least one opening. The release element with thereto belonging shear must in other words move at a distance over the cooled area sufficient to release the product. In some cases it may be sufficient that the shear is moved only over a part of the cooled surface for the product to be released. Factors that will affect this will be consistency and weight of the product, the bonding ability during freeze bonding, and the design of the shear.

The at least one shear can be designed with an edge in at least parts of its periphery. The edge is an advantage to reduce the force that is necessary to release the product. The shear angle or edge angle and the thickness of the shear will also affect when the product is released, and will decide to what degree the product is cut or wedged off the cooled face. The edge will also affect if the release element damages the product that is to be released.

The release element can be adjacent the thermal face, and be adapted to slide along this face. Normally the release element with the shear will slide along the thermal face, and it is therefore of importance that the friction between these faces is small to reduce wear and to reduce the necessary force imposed on the release element. These faces can accordingly be surfaces treated to reduce the friction or be made of materials with suitable properties.

The release element includes a first and a second outer position, and is moved between these two positions preferably by an actuator. The cooled part of the thermal face can correspond to at least one opening of the release element when this is in the first position, and the release element can block for the cooled part of the thermal face in the second position. In the first position the cooled area is exposed such that this area can be led towards the product for freeze bonding of the product. When the release element is moved towards the second position, the shear passes the cooled area where the product is freeze bonded, and cuts or wedges the product away from the cooled face such that the product is released. In the second position the shear or shears and the release apparatus accordingly covers at least parts of the cooled surface.

The thermal face may include at least one heated area and the heated area may be adjacent to the release element when this is in its first position to prevent freeze bonding of the release element, in particular when the release element is in the first position. The thermal face can accordingly be heated where the face not is cooled. The heating can be performed with electrical heating cables, may include channels for heated fluids, for instance from a refrigerating machine, or be heated in any other way. In this way the thermal face may include both cooled and heated areas, adapted to the shape of the release element.

The thermal face may be provided on a housing adapted for being placed on an apparatus for mechanical handling of humid products. The housing holds the various components of the apparatus, and is adapted to be secured to the apparatus for moving the products that are to be handled, for instance a robot.

The housing may include channels for circulation of a cooling medium and the channels may again be adapted for connection to an apparatus for cooling and circulation of the cooling medium.

The housing may be connected to an actuator for linear displacement of the release element in relation to the thermal face. The actuator may be pneumatic, hydraulic, driven by an electric motor, driven by an electromagnet or be of any other suitable type.

The thermal face may be curved with a radius of curvature R and this may be adapted to the product that is to be handled, such that it is ensured that the product will abut as large part of the cooled faces as possible.

The release element may be shaped to be mutually interfitting with the thermal face.

Furthermore the invention concerns a method for handling humid products with an apparatus as defined above. The method includes cooling the cooled area to a temperature below the freezing temperature of the humid product, lead the release element to a position where the cooled area is exposed, provide the apparatus in contact with the product that is to be handled such that the this freezes to the apparatus, handle the apparatus and the product until the product is in a desired position, and move the release element to take the product out of contact with the cooled surface such that the product is released.

Short description of the enclosed figures:

FIG. 1 is a perspective view of a gripping tool according to one embodiment of the invention;

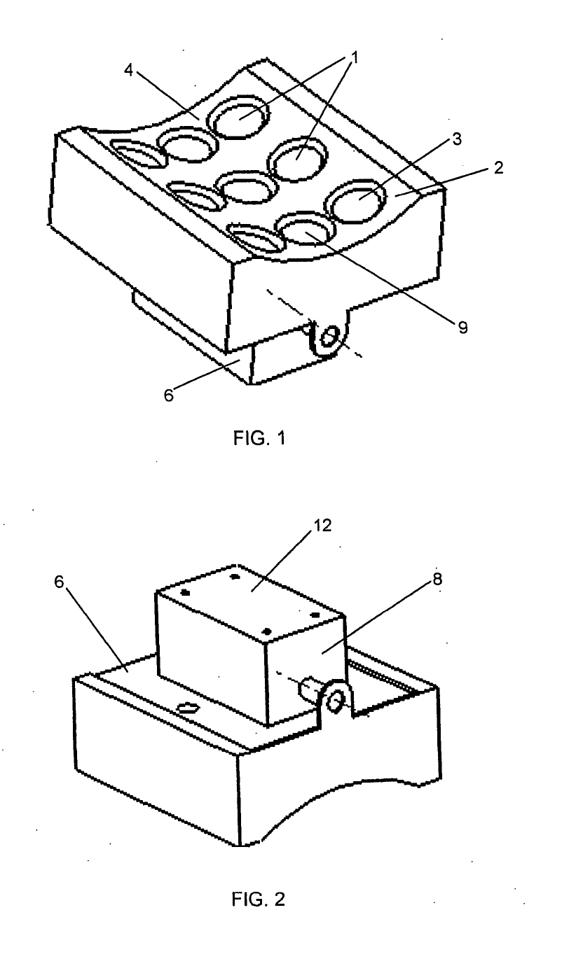

FIG. 2 is a perspective view of the apparatus shown on FIG. 1 from a different angle;

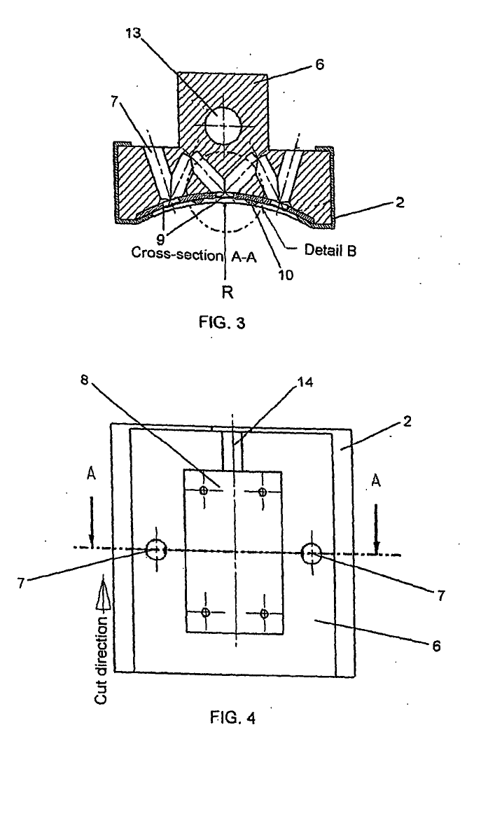

FIG. 3 is a cross sections A-A of the apparatus as shown on FIG. 4;

FIG. 4 is the apparatus seen from above; and

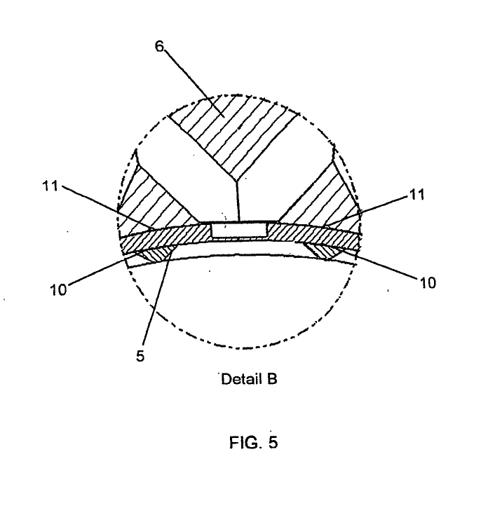

FIG. 5 shows a detail of FIG. 3.

Detailed description of the enclosed figures:

FIG. 1 shows an apparatus or gripping tool for handling humid products according to the invention. From the figure it is shown a release element 2 with nine openings 3 for exposing cooled areas 9 of a thermal face 1. The release element 2 has an around the openings situated release face 4. The nine openings 3 in the release element 2 are placed in a pattern. The thermal face 1 includes cooled areas 9 corresponding to the openings 3 in the release element 2, such that the openings 3 in the release element 2 exposes the cooled areas 9 on the thermal face 1 when the release element 2 is in a first position for gripping a humid product. The thermal face 1 also includes a heated area (not shown) over that part of the area that is covered by the release face 4 when this is placed in the gripping position for the apparatus. This is to prevent freeze bonding of the release element 2 to the thermal face 1. From FIG. 1 it is furthermore shown that the thermal face 1 is curved with a radius of curvature R and is adapted to the product that is to be handled, and that the release element 2 is shaped to be therein between mutually interfitting to the thermal face 1 and its radius of curvature R. From the figure it is also shown a housing 6. The housing 6 can be made of any suitable material, for instance stainless steel or a synthetic material. The material that is used is preferably of a type normally used in the food industry.

FIG. 2 shows the apparatus of FIG. 1, but the housing 6 and an actuator 8 for moving the release element 2 is more clearly shown. Furthermore the upper side of the housing 6 is shown. The actuator 8 is in the shown embodiment a part of the housing 6. From FIG. 2 it is also shown a fixing area 12 for fixing the apparatus to an apparatus for mechanical handling, for instance a robot. A suitable robot would for instance be a multi axis robot common in connection with handling objects.

FIG. 3 shows a cross section of the apparatus as shown on FIG. 1 and 2, where the configuration of the apparatus is shown in greater detail. In the housing 6 it is shown borings 7 for circulation of a cooling medium. The cooling medium impinges the cooled areas 9 on the thermal face 1 in certain areas. In the shown embodiment the thermal face 1 is a plate adapted to be secured to the housing 6. Recesses are milled in the plate where the cooled areas 9 are placed, such that the thickness of the plate in these areas is reduced for better heat transfer from the humid product and to the cooling medium. The thickness of the plate can in these areas for instance be 0.5 mm. The plate is preferably made of a material with good heat conductivity and suitable corrosive, hygienic and non-poisonous properties, for instance stainless steel. On the figure it is shown that the release element 2 is shaped as a plate, for instance of stainless steel, and that openings in the plate are shaped with an inclined angle such that it is created an edge, and such that the release element 2 can be compared to a knife cutting loose the humid freeze bonded product by activating the release element 2 in relation to the thermal face 1. The release element 2 is shown bent to a shape around the housing 6 such that the release element 2 can slide in a longitudinal direction along the housing 6 by activating the release element 2 for releasing the humid product in that the release element 2 cuts loose the humid product from the cooled area 9 of the thermal face 1. The release element does not need to extend far in the longitudinal direction. A length of 150 mm can be used in many cases, but this size will be adapted to the object that should be handled. Large round fish, or larger pieces of meat, for instance a roast, will obviously require a larger gripping face than smaller fillets. The diameter of the openings 3 can be in an order of magnitude of 25 mm and the release element can move in a longitudinal direction in an order of magnitude of a diameter of the opening 3. These dimensions can be varied after testing with various objects that are to be handled. Borings 13 in the housing 6 can be provided as a cylinder as a part of a pneumatic actuator for activating the release element 2. From FIG. 3 it also shown that the thermal face 1 includes heated areas 10 to prevent freeze bonding of the release element 2 to the thermal face 1.

The frozen circular faces can be cleaned for frost and other unwanted materials by running the release element 2 back and forth some times before a new object is to be “gripped”.

FIG. 4 shows the apparatus of FIGS. 1, 2 and 3 from above. Cross-section A-A on FIG. 4 show cross-section A-A of FIG. 3. FIG. 4 shows furthermore release element 2, housing 6, actuator 8 and a piston 14 in the actuator 8. Furthermore the fixing area for fixing the apparatus to a robot is shown. The figure also shows borings 7 for circulation of cooling fluid.

FIG. 5 shows a detail of the apparatus, as shown with a circle on FIG. 3. The figure shows heating cables 11 for heating the thermal face 1 in the area where the thermal face 1 abuts the release element 2 when this is in its first position, placed in the housing 6. Furthermore it is shown that the release element includes at least one edge along its openings. It is also shown that the thermal face is made of a plate, and that recesses are milled in this plate on the cooled part to improve heat transfer from the humid product and to the cooling medium.

1. An apparatus for handling humid products, with a thermal face (1) with a cooled area (9) over at least a part of the face (1), characterized by at least one release element (2) with at least one release shear, said release element (2) with said release shear being movably provided in relation to the cooled area (9).

2. The apparatus of claim 1,
characterized in that the at least one release shear is formed by the edge of at least one opening (3) for exposing the cooled area (9), and a release face (4) situated around the opening.

3. The apparatus of claim 1,
characterized in that the release element (2) is adapted to be movable in a direction substantially parallel to the cooled area (9).

4. The apparatus of claim 1,
characterized in that the release element (2) is made of a plate.

5. The apparatus of claim 2,
characterized in that the release element (2) includes a plurality of openings (3) in a pattern.

6. The apparatus of claim 2,
characterized in that the release element (2) is adapted to be movable in a distance sufficient such that the release face (4) around the at least one opening (3) can reach the entire area of the cooled area (9) exposed by the at least one opening (3).

7. The apparatus of claim 2,
characterized in that the at least one opening (3) is made with an edge (5) at least in parts of its periphery.

8. The apparatus of claim 1,
characterized in that the release element (2) is adjacent the thermal face (1), and is provided to slide along this face.

9. The apparatus of claim 2,
characterized in that the cooled part (9) of the thermal face (1) coincides with at least one opening (3) of the release element (2) when this is in a first position, and the release element (2) blocks for the cooled part (9) of the thermal face in a second position.

10. The apparatus of claim 9,
characterized in that the thermal face (1) includes at least one heated area (10) and that the heated area (10) abuts the release element (2) when this is in its first position.

11. The apparatus of claim 1,
characterized in that the thermal face (1) is provided on a housing (6) adapted for being placed on an apparatus for mechanical handling of humid products.

12. The apparatus of claim 9,
characterized in that the housing (6) includes channels (7) for circulation of a cooling medium and that the channels (7) are adapted for connection with an apparatus for cooling and circulation of the cooling medium.

13. The apparatus of claim 9,
characterized in that the housing (6) is connected to an actuator (8) for linear displacement of the release element (2) in relation to the thermal face (1).

14. The apparatus of claim 1,
characterized in that the thermal face (1) is curved with a radius of curvature adapted to the product that is to be handled, and that the release element (2) is shaped for mutual interfitting placement towards the thermal face (1).

15. A method for handling humid products with an apparatus according to claim 1,
characterized in the following steps:
cool the cooled area (9) to a temperature below the freezing temperature of the humid product;
lead the release element (2) to a position where the cooled area (9) is exposed;
provide the apparatus in contact with the product that is to be handled such that the product freeze bonds to the apparatus;
handling the apparatus and the product until the product is in a desired position; and
move the release element (2) to bring the product out of contact with the cold face (9) such that the product is released.
